(19) United States
(12) Patent Application Publication
(10) Pub. No.: US 2026/0105111 A1
(43) Pub. Date: Apr. 16, 2026

(54) ARTIFICIAL INTELLIGENT AGENT CROWDSOURCING

(71) Applicant: FOURSQUARE LABS, INC., New York, NY (US)

(72) Inventors: Vikram Gundeti, Sammamish, WA (US); Anastassia Etropolski, East Grand Rapids, MI (US)

(21) Appl. No.: 19/358,011

(22) Filed: Oct. 14, 2025

Related U.S. Application Data
(60) Provisional application No. 63/707,092, filed on Oct. 14, 2024.

(51) Int. Cl. G06F 16/9536

(52) U.S. Cl. CPC G06F 16/9536

(57) ABSTRACT

Aspects of the present disclosure relate to systems and methods for updating description of a place of interest. The systems and methods comprise receiving a proposed place edit to a description of a place as a report from a reporting agent, inserting the report with the proposed place edit in a queue of proposed place edits to the place, receiving one or more votes on accepting the proposed place edit by a voting agent, and updating the description of the place according to the accepted edit. The reporting agent performs according to a first machine learning model that automatically generates an edit to a description of a place of interest based on information obtained by crawling one or more websites that publish information about places of interest. The voting agent comprises a second machine learning model that predicts acceptance of a given edit to a description of a place.

### CROSS REFERENCE TO RELATED APPLICATIONS

This application claims priority to U.S. Provisional Patent Application No. 63/707,092, filed on October 14, 2024, the disclosure of which is hereby incorporated by reference in its entirety.

### BACKGROUND

Use of crowdsourcing for building and maintaining information about point of interests has become popular. As a part of social networking, users in general public posts information about points of interests and other users append the information from their perspectives. Some users endorse or disfavor the posted information.

It is with respect to these and other general considerations that the aspects disclosed herein have been made. Although relatively specific problems may be discussed, it should be understood that the examples should not be limited to solving the specific problems identified in the background or elsewhere in this disclosure.

### SUMMARY

Aspects of the present disclosure relate to systems and methods for updating description of a place of interest. The systems and methods comprise receiving a proposed place edit to a description of a place as a report from a reporting agent, inserting the report with the proposed place edit in a queue of proposed place edits to the place, receiving one or more votes on accepting the proposed place edit by a voting agent, and updating the description of the place according to the accepted edit. The reporting agent performs according to a first machine learning model that automatically generates an edit to a description of a place of interest based on information obtained by crawling one or more websites that publish information about places of interest. The voting agent comprises a second machine learning model that predicts acceptance of a given edit to a description of a place. In particular, the voting agent comprises a website search agent and a verification agent. The website search agent, as executed by the second machine learning model, crawls one or more websites and identifies content of the edit to the description of the place. The verification agent, further executed by the second machine learning model, performs verification of the content of the proposed place edit by comparing the content against contents of the websites as identified by the website search agent.

Leveraging accurate location data unlocks powerful opportunities across business operations. With latest points-of-interest data with accuracy, the business operations enrich datasets for deeper insights, drive hyper-personalized user experiences, and make data-driven decisions.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Non-limiting and non-exhaustive examples are described with reference to the following figures.

FIG. 1 illustrates an overview and exemplary superuser dashboard in accordance with aspects of the present disclosure.

FIG. 2 illustrates an example user interface operable to receive votes on proposed place edits to description of a place of interest in accordance with aspects of the present disclosure.

FIG. 3 illustrates an exemplary system for creating and maintaining a collection of information about places of interests by a machine learning model in accordance with aspects of the present disclosure.

FIG. 4 illustrates an exemplary system in accordance with aspects of the present disclosure.

FIG. 5 depicts an exemplary audit log of editing description of a place of interest in accordance with aspects of the present disclosure.

FIG. 6 illustrates a simplified block diagram of a device with which aspects of the present disclosure may be practiced, according to aspects described herein.

FIG. 7 illustrates an example method for accepting proposed place edit to description of a place of interest in accordance with aspects of the present disclosure.

### DETAILED DESCRIPTION

Various aspects of the disclosure are described more fully below with reference to the accompanying drawings, which from a part hereof, and which show specific example aspects. However, different aspects of the disclosure may be implemented in many ways and should not be construed as limited to the aspects set forth herein; rather, these aspects are provided so that this disclosure will be thorough and complete and will fully convey the scope of the aspects to those skilled in the art. Aspects may be practiced as methods, systems, or devices. Accordingly, aspects may take the form of a hardware implementation, an entirely software implementation or an implementation combining software and hardware aspects. The following detailed description is, therefore, not to be taken in a limiting sense.

Aspects of the present disclosure relate to a system (e.g., Places Engine) that integrates various crowdsourcing and machine learning technologies to manage real-world data. This new engine addresses the challenge of maintaining a database (e.g., a Places database) storing data that reflects actual, real-word information, which is in combination with user-generated insights, and data integration as driven automatically by machine learning models to deliver more reliable data.

In one aspect, a crowdsourcing system according to the present disclosure is operable to leverage the power of the active users of on mobile apps to create and maintain a robust database of places/points of interest (POIs). This crowdsourcing components of systems disclosed herein allow any user to create a new place or suggest edits to existing places, fostering a dynamic and responsive dataset that could quickly adapt to changes in the real world. The edits proposed by user are then subject to a unique verification process.

The crowdsourcing system utilizes a hierarchy of user roles and permissions. Regular users may act as “reporters,” proposing edits to add new places or edits to existing ones. To maintain data quality, the system leverages a special class of users called “superusers.” These superusers had the ability to both report and “vote” on proposed place edits, acting as a filter to ensure accuracy. The superuser system, in exemplary aspects, may be further stratified into levels, ranging from 1 to 10, for example, with higher levels granted more authority and responsibility in the edit approval process. These levels depended on the user’s credibility and their track record with past edits.

In examples, an edit to a description of a place of interest has a dynamically computed acceptance threshold. The acceptance threshold varies based on various factors including but not limited to popularity and/or other contextual rules of a place of interest. Users had dynamic trust scores based on their role and accuracy of past contributions. Reporters earned trust scores by making accurate suggestions, while superusers earned them by approving correct edits and rejecting incorrect ones. These scores are adjusted continuously, rewarding accuracy and penalizing errors.

In examples, an edit to description of place of interest may be accepted in at least one of two ways. First, the edit may be accepted according to a combined trust scores of multiple reporters. Additionally, or alternatively, the edit may be accepted based on votes made by superusers. Availability of the two approaches enables quick approval from broad consensus among users or trusted sources, while contentious changes may be reviewed more in detail by superusers. The balance of acceptance operations between distinct groups enables ensuring rapid updates while maintaining data integrity. The balance further enables adapting the verification process according to the importance of each change to description of a place of interest.

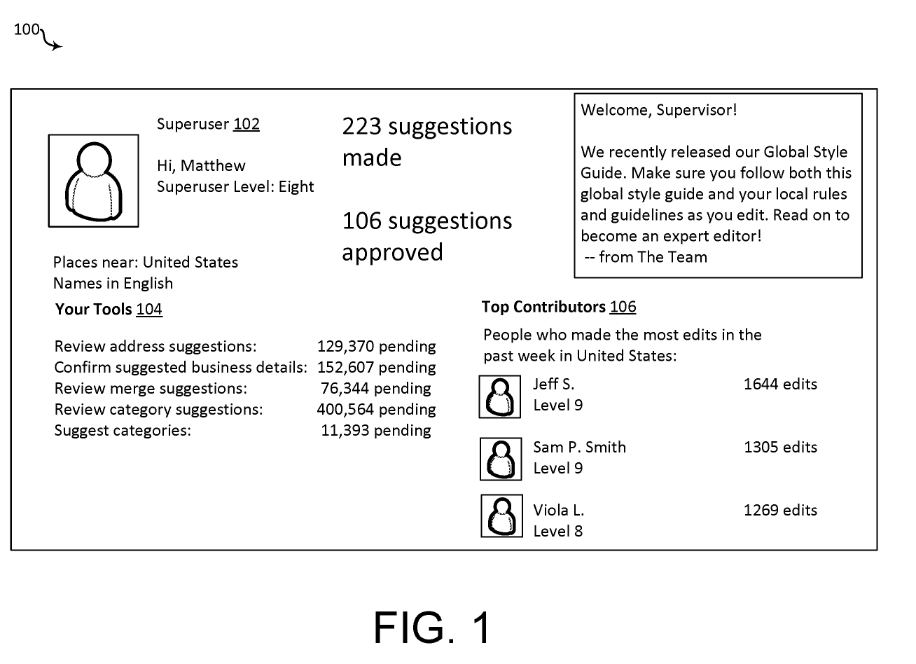

FIG. 1 illustrates an overview and exemplary superuser dashboard in accordance with aspects of the present disclosure. As illustrated, the exemplary superuser dashboard 100 comprises indication of a superuser 102 with a superuser level (e.g., level eight), tools 104, and a top contributors list 106.

In aspects, a superuser represents a user with a privilege that is higher than a user in the system. The privilege may include casting a vote that may have a heavier weight than endorsement made by a user on a proposed place edit to description of a place of interest to accept or deny the proposed place edit. A superuser level may indicate a weighted position of a superuser relative to superusers at other superuser levels. In examples, a superuser level one indicates less weight than a superuser level eight. Accordingly, a superuser with a higher superuser level may override a vote casted by a superuser with a lower superuser level.

In examples, the dashboard 100 further indicates tools that the superuser may use to act upon suggestions and/or proposals for editing description of a place of interest. The tools may include but not limited to reviewing address suggestion, confirming suggested business details, reviewing suggestions for merging descriptions of places of interest, reviewing category suggestions, suggesting categories of places of interest, and the like. The dashboard 100 may indicate numbers of outstanding cases for review/confirm/suggest. The dashboard 100 may further indicate a top contributor list 106, listing those top contributors making proposals for editing descriptions of places of interest. In examples, the list describes top contributors in the order of numbers of proposed place edits made by respective contributors. The list may be specific to a select region (e.g., United States, New York, and the like).

As described above, the dashboard 100 as a graphical user interface enables a superuser to review a state of a queue of pending edit proposals on descriptions of places of interests at a glance. The graphical user interface further enables the superuser to understand a weight level and act upon respective proposals in the queue.

As will be appreciated, the various methods, devices, applications, features, etc., described with respect to FIG. 1 are not intended to limit the dashboard 100 to being processed by the particular applications and features described.

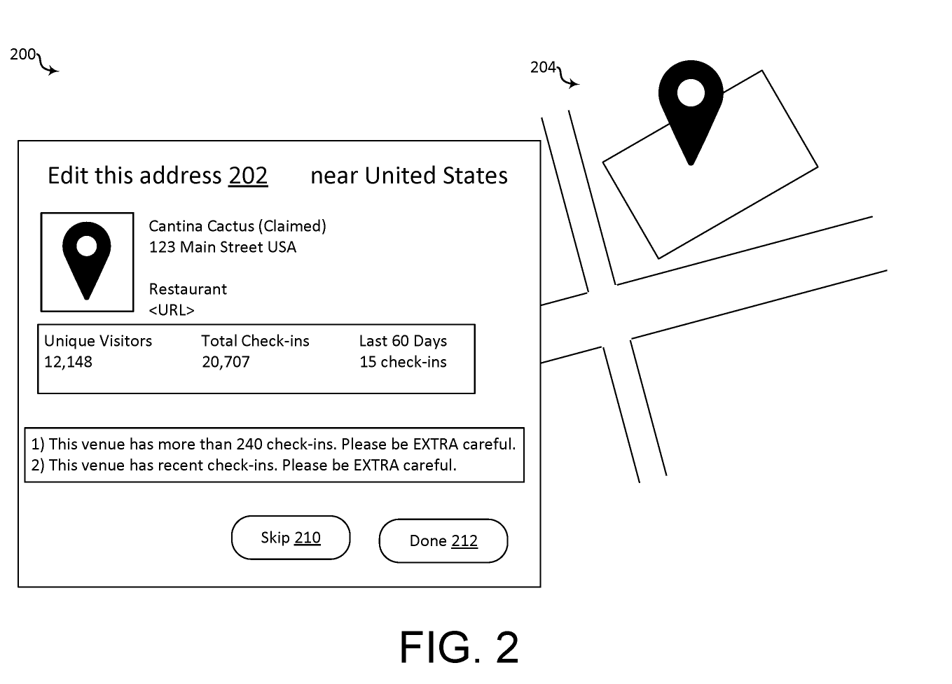

FIG. 2 illustrates an example user interface operable to receive votes on proposed place edits to description of a place of interest in accordance with aspects of the present disclosure.

While a traditional crowdsourcing system may effectively capture nuanced insights in describing places of interests, reliance made by the traditional crowdsourcing system on user activity and superuser approvals may limit its performance. For example, the reliance on manual operations may lead to a substantial backlog of unprocessed edits. The backlog may cause delay in accepting and publishing updates that are valuable, further affecting the freshness and accuracy of the dataset.

Aspects of the present disclosure also relate to a machine learning solution to build and maintain a comprehensive database of places around the world from digital sources, leveraging the vast amount of information available online and from trusted partners.

In aspects, a user interface 200 comprises a pane for editing an address 202 and a map 204. The pane for editing an address 202 indicates descriptions about a place of interest. In examples, the description includes a name (e.g., Cantina Cactus (claimed)) and an address (e.g., 123 Main Street, USA), of the place of interest, a type of the place of interest (e.g., a restaurant), statistics about the place of interest, and notes about the place of interest. The statistics may include by not limited to, a number of unique visitors, a total number of check-ins at the place of interest, and a number of check-ins during the last 60 days (or a predetermined number of days). The notes may indicate a caution to an operator based on a state of the place of interest. The state of the place of interest may include but not limited to a number of recent check-ins (e.g., more than 240 check-ins) and a presence of a recent check-ins at the place of interest. A pin icon may point to a location of the place of interest in the map 204.

The user interface 200 may further indicate interactive buttons. For example, selecting a skip button 210 enables skipping the current proposed place edit and move to a next proposed place edit in the queue. Selecting a done button 212 may cause save the edited content and close the user interface. The map 204 graphically indicates a location of the place of interest.

As will be appreciated, the various methods, devices, applications, features, etc., described with respect to FIG. 2 are not intended to limit the user interface 200 to being generated by the particular applications and features described. Accordingly, additional configurations may be used to practice the methods and systems herein and/or features and applications described may be excluded without departing from the methods and systems disclosed herein.

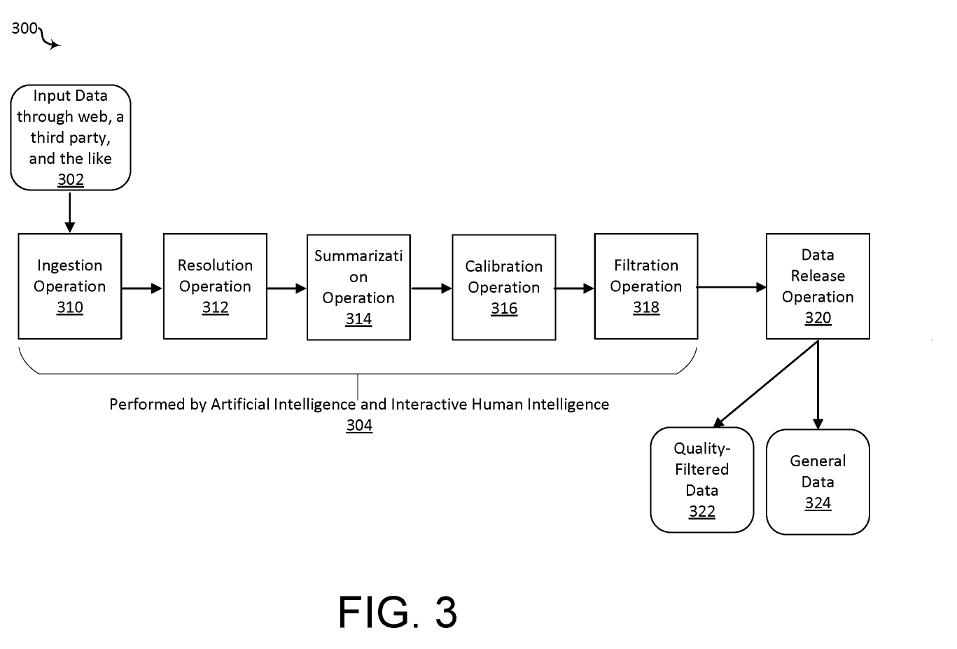

FIG. 3 illustrates an exemplary system for creating and maintaining a collection of information about places of interests by a machine learning model in accordance with aspects of the present disclosure.

In aspects, a system 300 comprises ingestion operation 310, resolution operation 312, summarization operation 314, calibration operation 316, filtration operation 318, and data release operation 320. The system 300 receives input data 302 and outputs quality-filtered data 322 and general data 324 as output.

The ingestion operation 310 comprises ingesting input data 302 as raw data from sources including but not limited to web crawls, syndicators, and partners. Then, the raw data from respective sources was canonicalized to create summary inputs.

The resolution operation 312 comprises matching input data 302 to existing entries of description of a place of interest or added as description of a new place of interest. Accordingly, the resolution operation 312 generating accurate and non-redundant data records.

The summarization operation 314 comprises aggregating conflicting data into a single authoritative record as an edit to description of a place of interest. The aggregation may be based on consensus methods. Additionally, or alternatively, conflicting data for aggregation may be specified by a machine learning model according to features of the respective data.

The calibration operation 316 comprises assessing quality of respective records and update parameters of a machine learning model to train the machine learning model. Indication of the quality may include but not limited to accessibility and operational status of places of interests. The calibration operation 316 may be based on heuristic. An example of training of the machine learning model may include interactively adding human-verified annotations by a superuser.

The filtration operation 318 comprises checking quality of the respective records and determining which edited records to include in description of a place of interest. The filtration operation 318 may be based on factors including but not limited to completeness, source credibility, and consistency of editing description of a place of interest.

The series of operations as a multi-stage operation including the ingestion operation 310, the resolution operation 312, the summarization operation 314, the calibration operation 316, and the filtration operation 318 may be performed by a combination of artificial intelligence by a machine learning model and through an interactive human intelligence (304).The multi-stage operations as described above enables the system 300 to leverage machine learning to maintain a database with accuracy. The multi-stage operation further reflects the dynamic nature of real-world locations.

While effective in integrating vast amounts of data from multiple sources, a machine learning solution may be limited by the lack of human verification in the process. This may result in inaccuracies, especially for subtle changes to businesses or locations that might not be immediately reflected in the digital sources. Additionally, it may result in the underrepresentation of places lacking an online presence in the dataset, thus creating a bias in the dataset towards digitally visible locations.

Aspects of the present disclosure address the limitations of the disclosed crowdsourcing and machine learning solutions by providing a combined artificial intelligence crowdsource solution by integrating features of the two solutions. In initial testing, preliminary outcomes of this integration were encouraging. There was a notable expansion in global location coverage and a marked improvement in the accuracy of performance of tasks by machine learning models, attributable to the integration of the crowdsourced data as ground truth data. These early successes show that an integrated approach is possible. However, further analysis revealed several opportunities to address some limitations:

Lack of continuous human feedback: By treating crowdsourced data as merely another input source, the solution inadvertently undermined the nuanced and granular real-time human verification process that was a cornerstone of the crowdsourced solution.

Insufficient Granular Observability: While it is possible to identify quality issues at the aggregate level through enhanced calibration, it may be difficult to acquire the telemetry needed to reason about the correctness of data at an individual record level. For example, it is difficult to understand why a particular place record changed values for specific attributes between releases.

Limited levers for quality improvements: The primary method for improving data quality – the addition of new digital sources using a machine learning solution – may be susceptible to what the “Digital Echo Chamber” effect. The Digital Echo Chamber effect represents a significant challenge in the location data industry. This phenomenon occurs when location datasets are published online and subsequently used by other companies to create new datasets, often in combination with the original sources. This cycle repeats, with each iteration affecting future datasets. As a result, the origination of data becomes unclear. Errors may spread across multiple datasets. This issue is especially concerning with the rise of advanced technologies including, but not limited to, Large Language Models (LLMs), which make web crawling for structured information with accuracy. As these technologies become more common, the risk of spreading unverified, inaccurate data grows significantly.

The recognition of these challenges spurred changes to the integrated solution. To achieve a goal of creating the most comprehensive and accurate global location dataset, aspects of the present disclosure provide a methodology that balanced the broad reach of digital data paired with the precision and granularity of real-time human verified insights.

In aspects, a machine learning model may comprise a neural network model, a generative model, a transformer model, a large language model, and the like. The machine learning model be trained by using supervised /un-supervised training data. Further, the machine learning model may be fine-tuned to enhance accuracy of generating descriptions of places of interest in predetermined regions and/or predetermined categories of places of interest.

As will be appreciated, the various methods, devices, applications, features, etc., described with respect to FIG. 3 are not intended to limit the system 300 to being performed by the particular applications and features described.

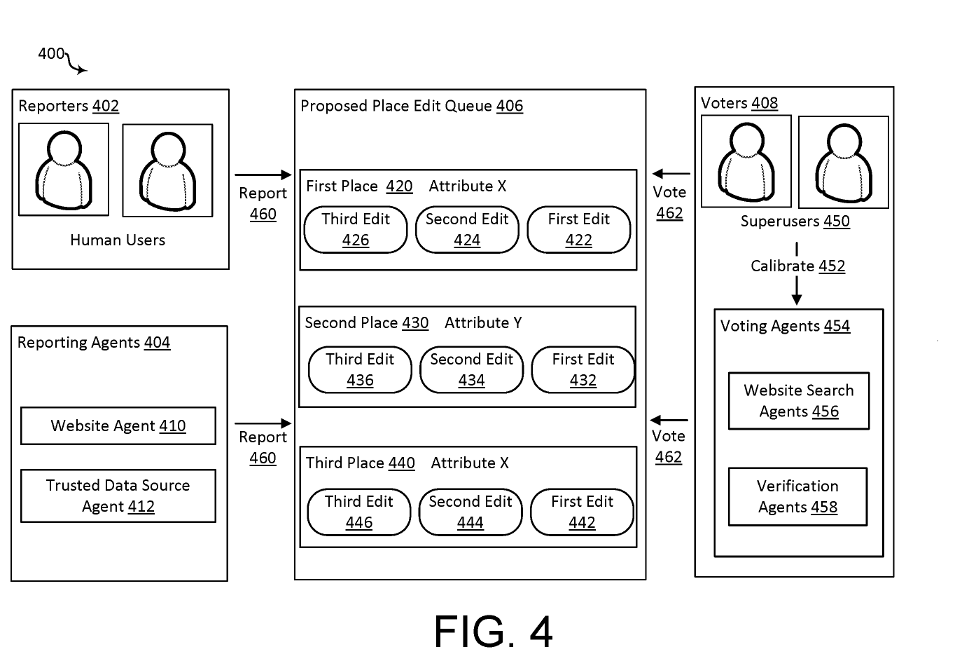

FIG. 4 illustrates an exemplary system in accordance with aspects of the present disclosure. In aspects, FIG. 4 depicts an exemplary AI Agent Crowdsourcing system, also referred to as a Places Engine. The new integration model described in FIG. 4 addresses the limitations as described above. In the depicted aspect, components of the crowdsourcing solution are used as a foundation of the Places Engine. The Places Engine provides two types of AI-powered agents that performs respective predetermined tasks in the crowd sourced system: reporting agent and voting agent. In aspects, the voting agent may further comprise website searching agent and verification agent. One of skill in the art will appreciate the fewer or additional agents may be employed by the Places Engine without departing from the scope of this disclosure.

The system 400 comprises reporters 402, reporting agents 404, proposed place edit queue 406, and voters 408. The reporters 402 comprises one or more human users who respectively create a proposal for editing description of a place of interest. In aspects, the reporters 402 report (460) proposed place edits to description of a place of interest as at least a part of crowdsourcing for review and for acceptance by the voters 408.

The reporting agents 404 comprises website agent 410 and trusted data source agent 412. The website agent 410 automatically generates, by a machine learning model, a proposal for editing / creating description of a place of interest. In some aspects, there may be a plurality of website agents where respective website agents are specific to distinct types of places of interests and/or websites to retrieve content from websites as candidates for generating a proposal for editing/creating description of a place of interest. The trusted data source agent 412 may retrieve information for editing/creating description of a place of interest with accuracy by accessing predetermined websites and blogs as trusted data sources. In aspects, the reporting agents 404 automatically generate and report (460) proposed place edits to description of a place of interest as at least a part of crowdsourcing for review and for acceptance by the voters 408.

The proposed place edit queue 406 represents queues of proposals for editing description of places of interest. In aspects, the proposed place edit queue 406 comprises a list of places and one or more instances of proposed place edit. In aspects, the proposed place edit queue 406 comprises proposals for editing first place 420, second place 430, third place 440, and the like. Respective places of interest comprise one or more proposals for editing in the queue. In aspects, the first place 420 with Attribute X (e.g., address) comprises first edit 422, second edit 424, and third edit 426. The second place 430 with Attribute Y (a type of place) comprises first edit 432, second edit 434, and third edit 436. The third place 440 with Attribute X comprises first edit 442, second edit 444, and third edit 446. In aspects, either or both of the reporters 402 and the respective reporting agents 404 generate and report proposed place edit of a place of interest for insertion into the proposed place edit queue 406.

In aspects, the reporting agents 404 may be used for different digital sources. These agents actively identified changes in the data corresponding to the digital source they represented and compared them to the current authoritative representation of a Place. When a change was detected, a reporting agent is operable to propose and edit, ensuring that the dataset remains current with the latest information from all sources.

The voters 408 represents superusers 450 and voting agents 454. In aspects, the superusers 450 has privileges to vote (462) on respective proposals for editing descriptions of places of interests in the proposed place edit queue 406. Similarly, the voting agents 454 automatically performs casting of, by a machine learning model, a vote (462) with privileges on respective proposals for editing descriptions of places of interests in the proposed place edit queue 406.

In addition to using superusers, voting agents 454 are provided that act as AI-powered agents of superusers to access a queue (e.g., Proposed Place Edit Queue 406 as described in FIG. 4) and perform voting on one or more proposed place edits to description of a place of interest in the queue. In aspects, the voting agents 454 perform voting on proposed place edits as reported by both human users and the reporting agents 404, thereby creating a scalable system that is centered around the benefits of human curation on human-reported and/or agent-reported proposed place edits.

In examples, the voting agents 454 comprises website search agents 456 and verification agents 458. For instance, when a proposed place edit describes updating contact info on a place of interest, the website search agents 456 as a predetermined type of voting agents 454 may perform crawling webpages of the website corresponding to that place to ensure that the information in the woe is accurate. In doing so, the Places Engine, among providing other benefits, addresses the limitations of the solutions previously discussed. In aspects, the website search agents 456 perform web-crawling through websites to search for and identify content that is similar to respective proposed place edits to descriptions of places of interests.

In examples, the verification agents 458 performs verification on truthfulness of respective proposals for editing descriptions of places of interests. The verification may be based on comparison between content that has been retrieved from a website by the website search agents 456 and content in the proposed place edit. The voting agents 454 may vote for accepting respective proposed place edits based on outcome of the verification. Accordingly, the verification operation ensures accuracy of descriptions of places of interest.

In aspects, the calibrate operation 452 comprises the superusers 450 interactively calibrating rules and thresholds for voting on a proposed place edit. The calibrate operation 452 may comprise updating parameters of a previously-trained machine learning model to retrain the machine learning model. The retraining may be based on training data, which comprise ground truth data of a correct proposed place edit, correct information of a place of interest, and a correct selection of voting. In some other examples, the retraining may be performed by unsupervised training data, automated reinforcement learning, fine-tuning, and the like.

With agents and humans working side-by-side assuming different roles, aspects of the present disclosure not only ensure the humans regulating other humans but also the humans (i.e., the superusers) regulating the inputs and votes as provided by agents. In aspects, the voting agents 454 vote on non-contentious proposed place edit with accuracy, while allowing the superusers 450 (i.e., human voters) to focus on resolving (i.e., voting on) contentious proposed place edit.

In aspects, when a reporting agent of the reporting agents 404 reports edits with inaccurate content and are rejected by the superusers 450, the system 400 may automatically downgrade a trust score of that reporting agent. In aspects, the reporting agents 404 with a downgraded trust score are less influential in gaining acceptance by the voters 408 on proposed place edits being generated by the reporting agents 404.

In some other aspects, the system 400 further performs training a machine learning model of the reporting agents 404 by using training data for selecting a website and automatically creating proposed place edits to description of a place of interest with accuracy. In examples, the training data represents ground truth data for selecting a website with description on a place of interest.

When a voting agent of the voting agents 454 performs voting and accepts / reject a proposed place edit erroneously as detected by a superuser of the superusers 450, the detection by the superuser serves as a trigger to execute a feedback loop operation for the voting agent to recalibrate its parameters of a machine learning model, thereby training the machine learning model for improve performance of voting in subsequent operations.

When two sources of input data (i.e., the input data 302 as described in FIG. 3) are found to be reinforcing inaccurate edits as detected by a superuser, trust scores of both of the sources of input data are downgraded.

In aspects, the system 400, which may be referred to as a Places Engine, acts as a self-governing system that helps automatically and/or interactively mitigate the ‘digital echo chamber’ effect. In examples, during a testing phase and/or a production phase of the system 400, the superusers 450 interactively monitor and flag issues with the reporting agents 404 and the voting agents 454 for respective operations with insufficient levels of accuracy. For instance, edits submitted by a reporting agent with incorrectly formatted addresses may be immediately detected by a superuser and rejected by voting with accuracy.

In further aspects, the dataset integrates directly into a first party and third-party applications. For example, new places created from digital sources may be verified organically by application users through check-ins, tips, and photo uploads. In some aspects, the system 400 may receive photos and check-ins on a newly added place of interest as proposed place edit within a few days of time elapse.

In some aspects, the system 400 enables observing updates on descriptions of respective places of interests in per-place basis by using an audit log (not shown in FIG. 4) of editing descriptions of respective places of interest. The audit log stores a series of accepted edits that led to the latest representation of a place of interest. In effect, the system captures a detailed history of edits and users/reporting agents who proposed those edits. Availability of the audit log enables troubleshooting and identification of problematic input sources with accuracy by reviewing descriptions of places of interests with incorrect descriptions and values.

As will be appreciated, the various methods, devices, applications, features, etc., described with respect to FIG. 4 are not intended to limit the system 400 to being performed by the particular applications and features described.

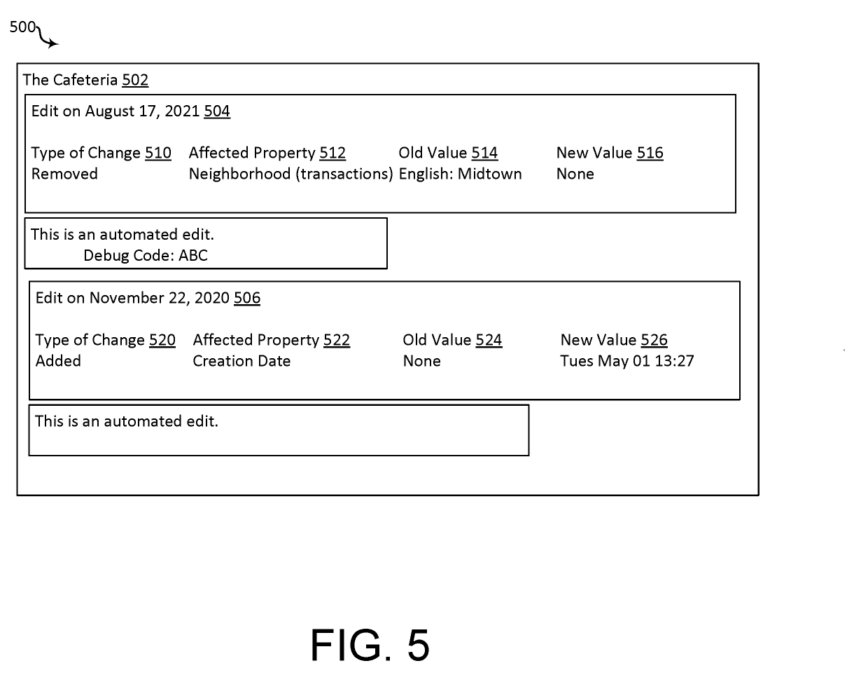

FIG. 5 depicts an exemplary audit log of editing description of a place of interest in accordance with aspects of the present disclosure. In aspects, an exemplary audit log 500 indicates a history of modifying description of one or more places of interest. In examples, the exemplary audit log 500 comprises an audit log of the cafeteria 502 as a place of interest. The exemplary audit log 500 further comprises one or more occurrences of editing description of the cafeteria 502. A first entry that indicates “edit of August 17 2021” (504) comprises type of change 510 of “Removed,” affected property 512 of “Macrohood (translations)”, old value 514 of “English: Midtown,” and new value 516 of “none.” Accordingly, the first entry describes removal of a value “English: Midtown” of a property “Macrohood (translations)” from description of the cafeteria as a place of interest. The first entry of the audit log further clarifies that the edit was made automatically, with a predetermined debug code “ABC.”

A second entry indicates edit on November 22, 2025 (506), which comprises type of change 520 of “Added,” affected property 522 of “Creation Date,” old value 524 of “None”, and new value 526 of “Tues May 01 13:27.” Accordingly, the second entry describes adding a creation data of “Tues May 01 13:27” to the Cafeteria. The log entry further indicates that the edit has been performed automatically.

As will be appreciated, the various methods, devices, applications, features, etc., described with respect to FIG. 5 are not intended to limit the exemplary audit log 500 as a data structure to being generated by the particular applications and features described. Accordingly, additional configurations may be used to practice the methods and systems herein and/or features and applications described may be excluded without departing from the methods and systems disclosed herein.

In aspects, the system (e.g., the Places Engine) according to the present disclosure provides a suite of tools to superusers. Respective tools enable enhancing the ability to improve and adapt places of interest data iteratively. The suite of tools includes but not limited to:

The Ability to Add New AI Voting Agents: The Places Engine is extendable by providing capability to install additional types voting agents. The additional type of voting agents may perform verifications and voting based on aspects that are distinct from existing types of voting agents. For examples, a new voting agent may use spatial information as the basis for performing voting on proposed place edits by focusing on geographical attributes of a place of interest.

Add new digital sources as Reporting Agents: As the system is self-governed with input from superusers, it allows adding more digital input sources without raising issues of perpetuating inaccuracies in descriptions of respective places of interest.

Prioritized Edit Queues: Tools that allow superusers to provide feedback on the most impactful edits that not only improve the quality of the Places data directly but also indirectly by helping calibrate the voter agents and reporter agents.

Voter and Reporter Application Programming Interfaces (APIs): The system of the present disclosure provides APIs to enable connecting third party applications and systems to provide graphical user interface for user. The graphical user interface enables interactively receive from human workforces various feedback on descriptions of places of interest. The APIs for third party applications to inject their human workforces further enable receiving and accepting proposals for editing descriptions of respective places of interests through interactive human operations.

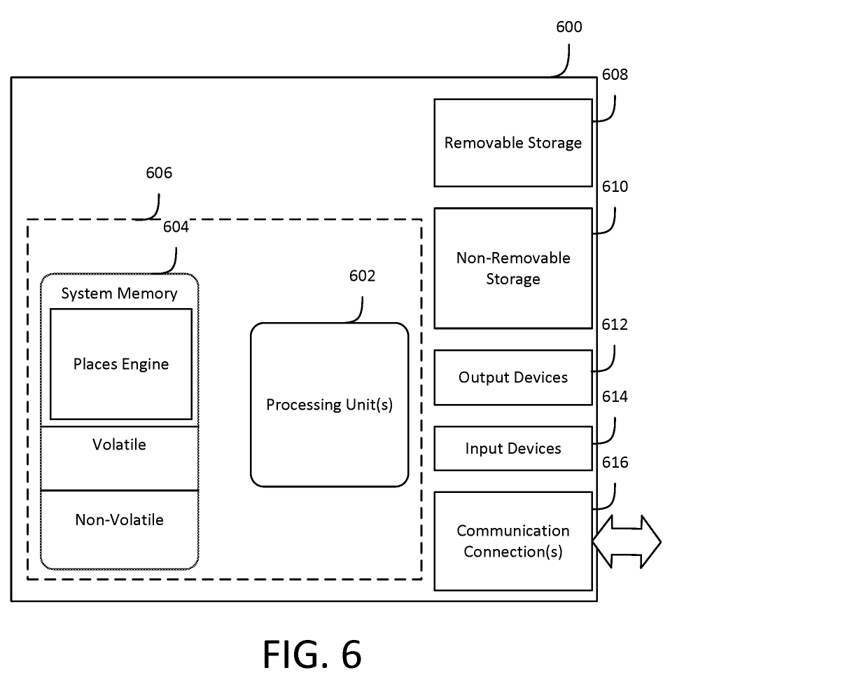

FIG. 6 illustrates a simplified block diagram of a device with which aspects of the present disclosure may be practiced, according to aspects described herein. In aspects, the device may be a mobile computing device or a Virtual Reality (VR) device for example. One or more of the present embodiments may be implemented in an operating environment 600. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smartphones, network PCs, minicomputers, mainframe computers, distributed computing environments that include any of the above systems or devices, and the like.

In its most basic configuration, the operating environment 600 typically includes at least one processing unit 602 and memory 604. Depending on the exact configuration and type of computing device, memory 604 (instructions to perform for performing the aspects of a Places Engine as disclosed herein) may be volatile (such as RAM), non-volatile (such as ROM, flash memory, etc.), or some combination of the two. This most basic configuration is illustrated in FIG. 6 by dashed line 606. Further, the operating environment 600 may also include storage devices (removable, 608, and/or non-removable, 610) including, but not limited to, magnetic or optical disks or tape. Similarly, the operating environment 600 may also have input device(s) 614 such as remote controller, keyboard, mouse, pen, voice input, on-board sensors, etc. and/or output device(s) 612 such as a display, speakers, printer, motors, etc. Also included in the environment may be one or more communication connections, 616, such as LAN, WAN, a near-field communications network, a cellular broadband network, point-to-point, etc.

Operating environment 600 typically includes at least some form of computer readable media. Computer readable media may be any available media that may be accessed by the at least one processing unit 602 or other devices comprising the operating environment. By way of example, and not limitation, computer readable media may comprise computer storage media and communication media. Computer storage media includes volatile and nonvolatile, removable, and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which may be used to store the desired information. Computer storage media does not include communication media. Computer storage media does not include a carrier wave or other propagated or modulated data signal.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

An operating environment according to the present disclosure may be a single computer operating in a networked environment using logical connections to one or more remote computers. The remote computer may be a personal computer, a server, a router, a network PC, a peer device, or other common network node, and typically includes many or all of the elements described above as well as others not so mentioned. The logical connections may include any method supported by available communications media. Such networking environments are commonplace in offices, enterprise-wide computer networks, intranets, and the Internet.

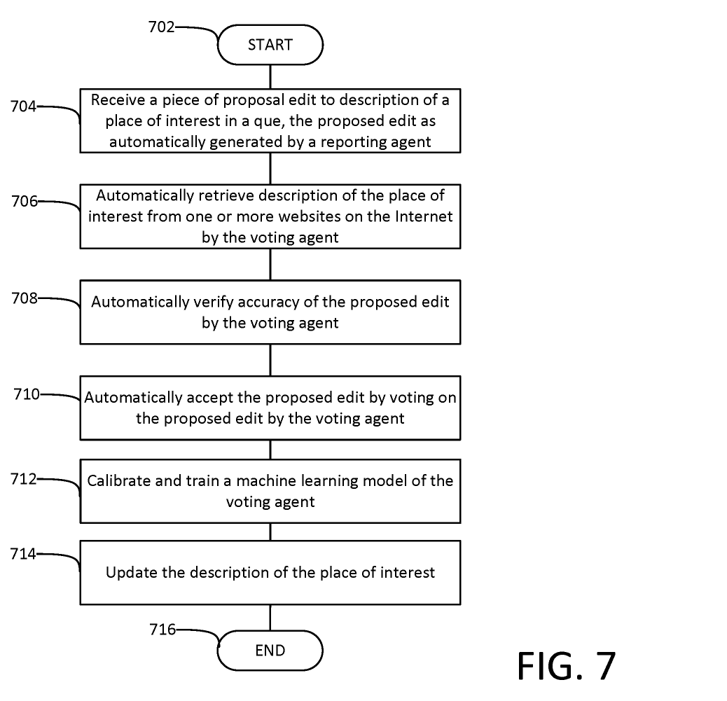

FIG. 7 illustrates an example method for accepting proposed place edit to description of a place of interest in accordance with aspects of the present disclosure. A general order of the operations for the example method 700 is shown in FIG. 7. Generally, the method 700 begins with start operation 702 and end with end operation 716. The method 700 may include more or fewer steps or may arrange the order of the steps differently than those shown in FIG. 7. The method 700 can be executed as a set of computer-executable instructions executed by a cloud system and encoded or stored on a computer readable medium. Further, the method 700 can be performed by gates or circuits associated with a processor, an Application-Specific Integrated Circuit (ASIC), a Field-Programmable Gate Array (FPGA), a System-on-Chip (SOC) or other hardware device. Hereinafter, the method 700 shall be explained with reference to the systems, components, devices, modules, software, data structures, data characteristic representations, signaling diagrams, methods, etc., described in conjunction with FIGS. 1, 2, 3, 4, 5, and 6.

Following start operation 702, the method 700 begins with receive operation 704, which receives a piece of proposed place edit to description of a place of interest in a que. In aspects, the proposed place edit has been automatically generated by a reporting agent (e.g., the reporting agent 404 as described in FIG. 4) by executing a machine learning model. In some other aspects, the piece of proposal edit may be manually generated through user interactive operations by a reporter.

At automatically retrieve operation 706, description of the place of interest is retrieved by accessing one or more websites on the internet. In aspects, a website search agent (e.g., the website search agent 456 as described in FIG. 4) of a voting agent (e.g., the voting agent 454 as described in FIG. 4) specifies and accesses, based on the proposed place edit, the one or more websites and retrieves the description of the place of interest according to a machine language model.

At automatically verify operation 708, accuracy of the proposed place edit to the description of the place of interest is verified by a verification agent (e.g., the verification agent 458 as described in FIG. 4) of the voting agent according to the machine learning model.

At automatically accept operation 710, the voting agent, based on a result of the verification of accuracy, accepts the proposed place edit to the description of the place of interest. In aspects, the automatically accept operation 710 is performed according to the machine learning model that determines whether to accept the proposed place edit. In some aspects, the accept operation 710 may be performed interactively by superusers (e.g., the superusers 450 as described in FIG. 4)

At calibrate operation 712, performance of the voting agent may be calibrated by training a machine learning model of the voting agent to enable the voting to verify and vote the proposed place edit with accuracy. In aspects, the training of the machine learning model is based on training data that describes ground truth data of description of a place of interest.

At update operation 714, the description of the place of interest is, based on the acceptance, updated according to the proposed place edit. In aspects, the update operation 714 may be performed automatically by the voting agent. The method 700 ends with the end operation 716. In aspects, the method 700 may be executed periodically or in response to occurrence of queuing proposed place edit to description of a place of interest.

As should be appreciated, operations 702-716 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The methods and order of operations for a method disclosed herein are exemplary, such that the steps of the method may be reorganized, added to, combined, and/or steps may be omitted as is contemplated by one having skill in the art. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Any of the one or more above aspects in combination with any other of the one or more aspect. Any of the one or more aspects as described herein.

What is claimed is:

1. A method for editing description of a place of interest by crowdsourcing, comprising:
receiving a piece of proposal for editing description of the place of interest;
accepting, based on verification of authenticity of the piece of proposal, the piece of proposal; and
updating the description of the place of interest according to the accepted piece of proposal.

2. The method according to claim 1, wherein the received piece of proposal is automatically created by a reporting agent by executing a first machine learning model, and the first machine learning model retrieves information about the place of interest over a network and creates the piece of proposal.

3. The method according to claim 1, wherein
the accepting the piece of proposal further comprises interactively accepting the piece of proposal through an interactive operations by a superuser with an elevated privilege to vote on the piece of proposal for acceptance.

4. The method according to claim 1, wherein accepting the piece of proposal further comprises:
automatically accepting, by a voting agent through executing a second machine learning model, the piece of proposal, wherein the voting agent comprises a website search agent and a verification agent, wherein the website search agent automatically performs searching and identifying, based on the piece of proposal, a website to retrieve content, and wherein the verification agent performs, based on the retrieved content from the website, automatic verification of the piece of proposal as ground truth data.

5. The method according to claim 4, further comprising:
calibrating, based on an automatic execution of the accepting the piece of proposal by the voting agent, one or more parameters of the second machine learning model through an interactive user interface to train the voting agent, thereby enabling the voting agent to accept the piece of proposal with accuracy.

6. The method according to claim 4, further comprising:
automatically creating, by a reporting agent through executing the first machine learning model, the piece of proposal for editing the description of the place of interest;
updating, based on a result of validating accuracy of the automatically created piece of proposal, one or more parameters of the first machine learning model, thereby training the first machine learning model to enable the reporting agent to perform creating another piece of proposal for editing the description of the place of interest with accuracy.

7. The method according to claim 4, further comprising:
updating, based on a result of the automatically accepting the piece of proposal by the voting agent, one or more parameters of the second machine learning model to calibrate the voting agent, thereby causing the voting agent to perform a subsequent automatic acceptance of another proposal for editing the description of the place of interest with accuracy.

8. The method according to claim 4, wherein the first machine learning model automatically generates, based on received information about the place of interest as input, the piece of proposal for editing the description of the place of interest.

9. The method according to claim 4, wherein the second machine learning model automatically marks, based on verifying content of the website describing the place of interest, acceptance of the piece of proposal to edit the description of the place of interest.

10. A computer-readable non-transitory recording medium storing a computer-executable program instructions that when executed by a processor cause a computer system to execute operations comprising:
receiving a piece of proposal for editing description of a place of interest;
accepting, based on verification of authenticity of the piece of proposal, the piece of proposal; and
updating the description of the place of interest according to the accepted piece of proposal.

11. The computer-readable non-transitory recording medium according to claim 10, wherein the received piece of proposal has been automatically created by a reporting agent by executing a first machine learning model, and the first machine learning model retrieves information about the place of interest over a network and creates the piece of proposal.

12. The computer-readable non-transitory recording medium according to claim 10, wherein the accepting the piece of proposal further comprises interactively accepting the piece of proposal through an interactive operations by a superuser with an elevated privilege to vote on the piece of proposal for acceptance.

13. The computer-readable non-transitory recording medium according to claim 10, wherein the accepting the piece of proposal further comprises automatically accepting, by a voting agent through executing a second machine learning model, the piece of proposal, the voting agent comprises a website search agent and a verification agent, the website search agent automatically performs searching and identifying, based on the piece of proposal, a website to retrieve content, and the verification agent performs, based on the retrieved content from the website, automatic verification of the piece of proposal as ground truth data.

14. The computer-readable non-transitory recording medium according to claim 13, the computer-executable program instructions when executed further causing the computer system to execute operations comprising:
calibrating, based on an automatic execution of the accepting the piece of proposal by the voting agent, one or more parameters of the second machine learning model through an interactive user interface to train the voting agent, thereby enabling the voting agent to accept the piece of proposal with accuracy.

15. The computer-readable non-transitory recording medium according to claim 13, the computer-executable program instructions when executed further causing the computer system to execute operations comprising:
automatically creating, by a reporting agent through executing the first machine learning model, the piece of proposal for editing the description of the place of interest;
updating, based on a result of validating accuracy of the automatically created piece of proposal, one or more parameters of the first machine learning model, thereby training the first machine learning model to enable the reporting agent to perform creating another piece of proposal for editing the description of the place of interest with accuracy.

16. The computer-readable non-transitory recording medium according to claim 13, the computer-executable program instructions when executed further causing the computer system to execute operations comprising:
updating, based on a result of the automatically accepting the piece of proposal by the voting agent, one or more parameters of the second machine learning model to calibrate the voting agent, thereby causing the voting agent to perform a subsequent automatic acceptance of another proposal for editing the description of the place of interest with accuracy.

17. The computer-readable non-transitory recording medium according to claim 13, wherein the first machine learning model automatically generates, based on received information about the place of interest as input, the piece of proposal for editing the description of the place of interest.

18. T The computer-readable non-transitory recording medium according to claim 13, wherein the second machine learning model automatically marks, based on verifying content of the website describing the place of interest, acceptance of the piece of proposal to edit the description of the place of interest.

19. A system comprising:
at least one processor; and
memory encoding computer executable instructions that, when executed by the at least one processor, perform operations comprising:
instantiating a reporting agent to automatically generate a proposed place edit to at least a part of a description of a place of interest; and
instantiating a voting agent, wherein the voting agent automatically marks acceptance of the proposed place edit created by the instantiated reporting agent.

20. The system of claim 10, wherein the proposed place edit is generated using a first machine learning model and wherein the acceptance of the proposed edit is marked using a second machine learning model.
